(19) United States
(12) Patent Application Publication
(10) Pub. No.: US 2021/0035235 A1
(43) Pub. Date: Feb. 4, 2021

(54) SYSTEM AND METHOD FOR DETECTING FRAUD AMONG TAX EXPERTS

(71) Applicant: Intuit Inc., Mountain View, CA (US)

(72) Inventors: Pawel Piotr Zawadzki, San Mateo, CA (US); Brian Milici, Cardiff-by-the-Sea, CA (US)

(73) Assignee: Intuit Inc., Mountain View, CA (US)

(21) Appl. No.: 16/525,925

(22) Filed: Jul. 30, 2019

(51) Int. Cl. G06Q 40/00; G06N 20/00; G06N 5/04

(52) U.S. Cl. CPC G06Q 40/123; G06N 5/045; G06N 20/00

(57) ABSTRACT

A method and system trains, with a machine learning process, an analysis model to detect anomalous behavior of tax professionals affiliated with a tax return preparation system. The analysis model is trained with a training set that includes contextual and behavioral data for a plurality of historical tax professionals. The trained analysis model then analyzes and generates risk scores for current tax professionals based on current behavioral and contextual data associated with the current tax professionals.

### BACKGROUND

Due to the complexity of government tax codes, millions of taxpayers find it necessary to obtain help in preparing and filing their tax returns. Electronic tax return preparation systems have become popular tools for helping taxpayers in this task. This is because electronic tax return preparation systems can provide a flexible, highly accessible, and affordable source of tax preparation assistance.

Nevertheless, in some instances users of tax return preparation systems may need the additional assistance of a human tax professional. Some tax return preparation systems maintain affiliation with a number of tax professionals that assist users to prepare and file their taxes. When a user of the tax return preparation system utilizes the services of an affiliated tax professional, the tax professional utilizes the tax return preparation system to assist the user to prepare the tax return.

To effectively and efficiently provide their service, affiliated tax professionals may have access to sensitive data related to users of the data management system. Additionally, affiliated tax professionals may have access to the tax return preparation system. Accordingly, there is the possibility that some tax professionals could attempt to misuse sensitive user data or misuse the tax return preparation system itself for illicit purposes such as fraudulent tax filings or identity theft.

Data management systems have sought to minimize the security risk associated with affiliated tax professionals by monitoring the behavior of the affiliated tax professionals. Some data management systems have utilized traditional anomaly detection algorithms to detect anomalous behavior among affiliated tax professionals because anomalous behavior may be an indication of misuse of sensitive user data or misuse of the tax return preparation system.

However, these traditional anomaly detection algorithms suffer from some drawbacks. For example, traditional anomaly detection algorithms are not well suited to capture seasonal effects. This can be a significant issue because behavior that is not anomalous at one time of the year may be anomalous at another time of the year. For instance, behavior that is normal in tax season may be anomalous at another time of the year. Unfortunately, traditional anomaly detection algorithms are not able to distinguish between such seasonal behaviors and therefore are prone to false positive, and false negative, anomalous behavior detections.

While in the discussion above electronic tax return preparation systems were used as a specific illustrative example, the fraud related issues discussed above are not limited to electronic tax return preparation systems. Fraudsters historically attempt to attack any systems that manage sensitive user data.

What is needed is a technical solution to the long-standing technical problem of more effectively detecting anomalous or fraudulent activity among tax professionals.

### SUMMARY

According to the disclosed embodiments, a tax return preparation system utilizes one or more machine learning-based behavioral and contextual data analysis models to detect anomalous behavior among tax professionals affiliated with the tax return preparation system. The disclosed analysis model can distinguish between behavior that is anomalous at one time of the year, but normal at another time of the year.

Using the disclosed embodiments, the tax return preparation system uses both behavioral data and contextual data to detect anomalous behavior among tax professionals. The tax return preparation system gathers behavioral and contextual data related to a number of tax professionals. The tax return preparation system trains the analysis model with a machine learning process to detect anomalous behavior based on the behavioral and contextual data.

The behavioral data utilized by the analysis model can include the actions of tax professionals when utilizing the tax return preparation system. The behavioral data can include clickstream data, communication data related to communications between the tax professionals and users of the tax return preparation system, and websites visited by the tax professionals. The contextual data utilized by the analysis model can include data related to the work locations of the tax professionals, the IP addresses of the tax professionals, and the tax filings of the tax professionals.

After the analysis model has been trained, the tax return preparation system uses the analysis model to analyze the behavioral and contextual data of tax professionals in order to detect anomalous behavior. The analysis model can generate risk scores for each tax professional. High risk scores, and the associated tax professionals, can then be flagged. The analysis model can provide explanations as to why the flagged tax professional is considered high risk. Once a tax professional is flagged as high risk, one or more protective actions are taken. These protective actions can include, but are not limited to, submitting data associated with the tax professional to one or more investigative systems or experts for follow up analysis. The investigative systems can then take actions such as suspending the tax professional if misbehavior has occurred.

Using the disclosed embodiments, one or more machine learning based behavioral and contextual data analysis models are used to analyze the contextual and behavioral data associated with tax professionals in order to detect anomalous behavior. As a result, the disclosed embodiments provide an effective and efficient technical solution to the long-standing technical problem of detecting anomalous behavior among tax professionals affiliated with tax return preparation systems.

### BRIEF DESCRIPTION OF THE DRAWINGS

FIG. 1 is a block diagram of a system for detecting anomalous behavior in tax professionals, in accordance with one embodiment.

FIG. 2 is a block diagram of a tax return preparation system, in accordance with one embodiment.

FIG. 3 is an illustration of training set data being provided to an analysis model, in accordance with one embodiment.

FIG. 4 is an illustration of current professional data being provided to an analysis model, in accordance with one embodiment.

FIG. 5 is a flow diagram of a process for detecting anomalous behavior in tax professionals, in accordance with one embodiment.

FIG. 6 is a flow diagram of a process for detecting anomalous behavior in tax professionals, in accordance with one embodiment.

Common reference numerals are used throughout the FIG.s and the detailed description to indicate like elements. One skilled in the art will readily recognize that the above FIG.s are examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be implemented in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

A tax return preparation system uses an analysis model to detect anomalous behavior by tax professionals affiliated with the tax return preparation system. The analysis model is trained with a machine learning process. The trained analysis model analyzes behavior and contextual data associated with the tax professionals and detects anomalies based on the analysis.

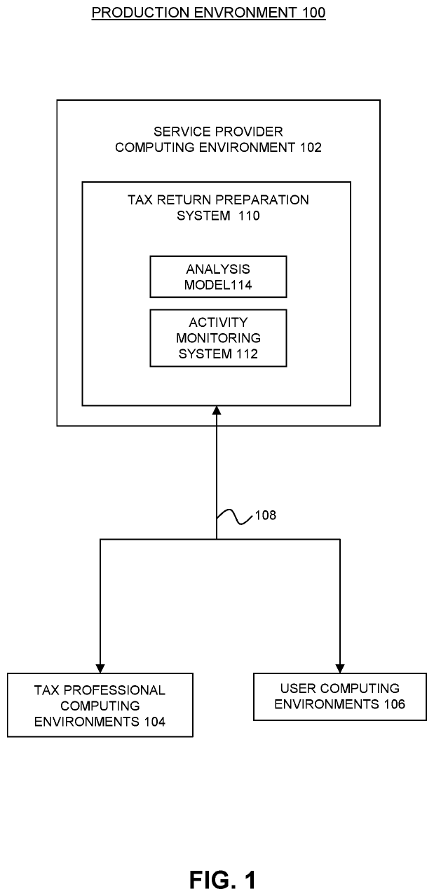

FIG. 1 illustrates a block diagram of a production environment 100 for detecting anomalous behavior among tax professionals affiliated with a tax return preparation system. The production environment 100 includes service provider computing environment 102, user computing environments 106, and tax professional computing environments 104. The service provider computing environment 102, the user computing environments 104, and the tax professional computing environments 106 are communicatively coupled together by one or more networks 108.

While the FIGs. and description primarily discuss embodiments describing a tax return preparation system and tax professionals, principles of the present disclosure extend to data management systems other than tax return preparation systems and affiliated data management professionals other than tax professionals. For example, a data management system can include a bookkeeping or personal accounting system. The affiliated data management professionals can include accounting professionals that assist users of the data management system to prepare accounting related documents or forms. Accordingly, data management systems other than tax return preparation systems fall within the scope of the present disclosure.

The service provider computing environment 102 hosts a tax return preparation system 110. The tax return preparation system 110 is an electronic tax return preparation system. The tax return preparation system 110 provides tax return preparation services to users. The tax return preparation system 110 guides users through the tax return preparation process. The tax return preparation system requests that the users provide tax related data. The tax return preparation system 110 then populates tax forms based on the information provided by the users. The tax return preparation system can then assist the users in filing the tax returns.

The user computing environments 106 enable users to interface with the tax return preparation system 110. Users can utilize the user computing environments 106 to connect with the tax return preparation system 110 to provide data to the tax return preparation system 110, and to receive tax return preparation services from the tax return preparation system 110. Users can also utilize the user computing environments 106 to contact a customer support system of the tax return preparation system 110.

The tax return preparation system 110 sometimes involves human tax professionals to assist users in preparing their taxes. In some cases, the personal tax related circumstances of the user may indicate that the user would benefit from using a tax professional in the tax return preparation process. In various cases, the tax return preparation system 110 can recommend that the user involve a tax professional affiliated with the tax return preparation system.

A tax professional affiliated with the tax return preparation system 110 is a tax professional that has a relationship with the tax return preparation system 110 such that the tax return preparation system may recommend the tax professional to users of the tax return preparation system. An affiliated tax professional may also have access to the tax return preparation system 110 to assist users of the tax return preparation system 110 to prepare tax returns or otherwise manage their tax related data.

During the tax return preparation process, the tax return preparation system 110 can recommend specific tax professionals to the user based on the characteristics of the user and the characteristics of the tax professionals. If the user selects to engage with one of the tax professionals, the tax return preparation system 110 contacts the tax professional. The user and the tax professional can then communicate with each other. The tax professional can then assist in preparing the user's tax return.

When a tax professional assists a user in preparing a tax return, the user may need to provide sensitive personal and financial information to the tax professional. This sensitive personal and financial information can include the user's name, a government identification number of the user, a birth date of the user, employment information of the user, an address of the user, a phone number of the user, income data of the user, tax return data of the user from a prior year, W-2 information of the user, and other kinds of sensitive data typically utilized to prepare a tax return. Additionally, similar types of personal and financial information may be provided regarding the user's spouse and dependents.

Of significance, this type of personal and professional user data can be subject to abuse, including various forms of ID theft. Consequently, anyone, including a tax professional, having this information has significant opportunity to commit fraud.

The tax return preparation system 110 can require affiliated tax professionals to use a specific network connection or portal associated with the tax return preparation system 110 when utilizing the professional tax return preparation application or when otherwise communicating with the user. The tax return preparation system 110 can require that the tax professionals login to a virtual private network associated with the tax return preparation system 110 when interacting with users or when otherwise utilizing the professional tax return preparation application.

The tax return preparation system can require that affiliated tax professionals utilize the tax return preparation system 110 when assisting users to prepare their taxes. In this case, the tax return preparation system 110 may provide a first tax return preparation application for users and a second tax return preparation application for professionals. The tax return preparation system 110 can require that affiliated tax professionals utilize the professional tax return preparation application provided by the tax return preparation system 110.

In extremely rare instances, it is possible that a tax professional could attempt to misuse sensitive personal information of users. Potential misconduct could include identity theft or filing false tax returns. Accordingly, the tax return preparation system 110 provides a protective system to identify risky or anomalous behavior among affiliated tax professionals.

To this end, the tax return preparation system utilizes the activity monitoring system 112 and the analysis model 114 to monitor the behavior of affiliated tax professionals and to identify anomalous behavior among the affiliated tax professionals. The activity monitoring system 112 gathers information related to the affiliated tax professionals. The analysis model 114 analyzes the collected information to determine whether a tax professional is engaged in anomalous or risky behavior. The tax return preparation system 110 can then investigate and take action against any tax professionals engaged in misconduct.

The activity monitoring system 112 monitors the activity of the tax professionals. Because the tax professional is required to utilize the professional tax return preparation application and to connect to the tax return preparation system 110 via a special network connection, the activity monitoring system 112 has the ability to monitor various activities of the affiliated tax professionals. The activity monitoring system collects and stores both behavioral data and contextual data related to affiliated tax professionals.

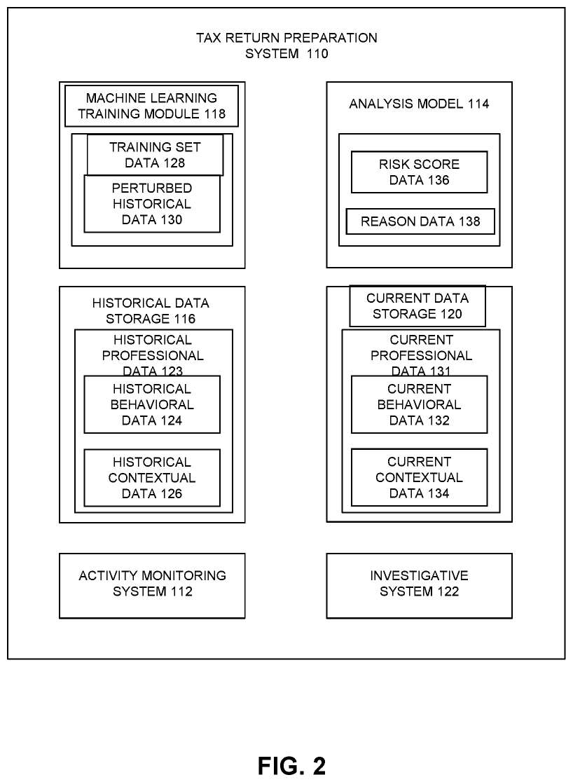

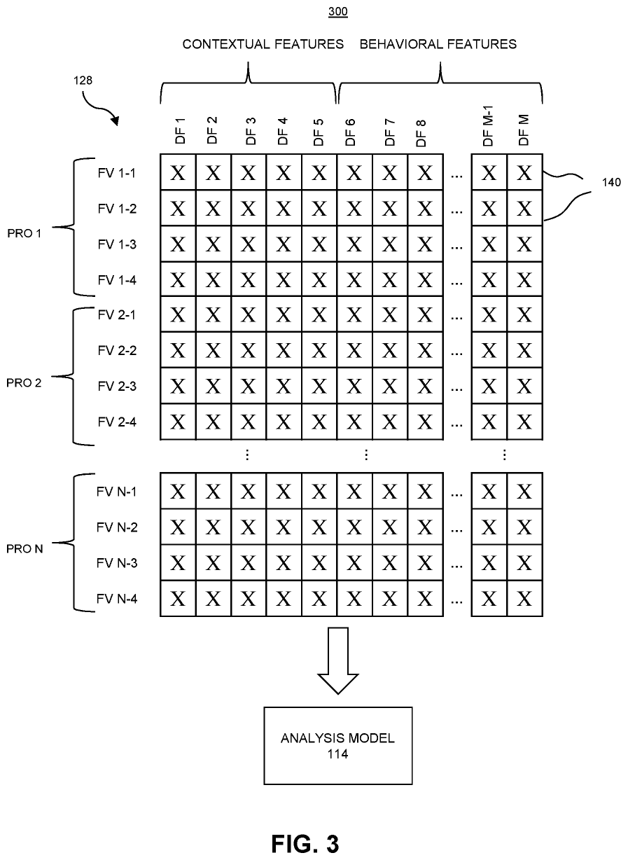

The behavioral data collected by the activity monitoring system 112 includes actions taken by the affiliated tax professionals when connected to the tax return preparation system 110 or when utilizing the professional tax return preparation application. Behavioral data can include clickstream data indicating specific actions and selections made by the affiliated tax professionals in the tax return preparation application. The behavioral data can include data related to communications between the affiliated tax professionals and users of the tax return preparation system 110. The behavioral data can include timesheets or other data related to how much time the affiliated tax professionals spent in assisting users of the tax return preparation system 110. Further details related to the behavioral data are provided below in relation to FIGS. 2 and 3.

The contextual data collected by the activity monitoring system 112 includes data related to the context in which the actions of the tax professionals occurred. Contextual data can include data related to the location of tax professionals when interacting with the tax return preparation system 110 or with users of the tax return preparation system 110. The contextual data can include network connection data associated with the types of Internet connection utilized by the tax professionals. The contextual data can include data related to IP addresses of the tax professionals when accessing the tax return preparation system 110 or assisting users of the tax return preparation system 110. Further details related to the contextual data are provided below in relation to FIGS. 2 and 3.

The tax return preparation system 110 utilizes the collected behavioral and contextual data in two ways. The tax return preparation system 110 utilizes the collected behavioral and contextual data to train the analysis model 114 in accordance with one or more machine learning process. After the analysis model 114 has been trained, the tax return preparation system passes the most recent behavioral and contextual data to the analysis model 114 so that the analysis model 114 can analyze the most recent behavioral and contextual data to identify anomalous or risky behavior among the tax professionals. Further details regarding the training of the analysis model 114 are provided below in relation to FIGS. 2 and 3.

The trained analysis model 114 generates a risk score for each affiliated tax professional. In particular, the most current behavioral and contextual data is gathered and formatted for each affiliated tax professional. The current behavioral contextual data is then passed to the analysis model 114. The analysis model 114 processes the current behavioral and contextual data for each affiliated tax professional. The analysis model 114 generates a risk score for each affiliated tax professional. The risk score is an indication of how anomalous the behavioral and contextual data is for a given tax professional. Highly anomalous behavior will result in a higher risk score.

The analysis model 114 can flag the highest risk scores. The analysis model 114 can flag risk scores that are greater than a threshold risk score. Alternatively, the analysis model 114 can flag a selected number of the highest risk scores, such as the 50 highest risk scores. The analysis model 114 can flag risk scores that meet a flagging criteria. The flagging criteria can include a threshold value, a percentage of the highest risk scores, or other criteria.

The analysis model 114 passes the flagged risk scores, or the data associated with the tax affiliates that have been flagged, to an investigative system. The investigative system then further investigates the flagged affiliated tax professionals. The investigative system can take actions against affiliated tax professionals engaged in misconduct. The actions can include suspending the tax affiliates, freezing the ability of the tax affiliates to file tax returns, severing a relationship with the tax affiliates, and providing data related to the misconduct to law enforcement.

The analysis model 114 can also generate risk score reasons. The risk score reasons detail what aspects of the contextual and behavioral data contributed most to the high risk score. The risk score reasons can assist the investigative systems and identifying misconduct among affiliated tax professionals.

Further details regarding the operation of the analysis model 114 are provided below in relation to FIGS. 2-4.

FIG. 2 is a block diagram of a tax return preparation system 110, according to one embodiment. The tax return preparation system 110 includes an activity monitoring system 112, an analysis model 114, a historical data storage 116, a machine learning training module 118, a current data storage 120, and an investigative system 122. FIG. 2 illustrates some components of the tax return preparation system 110 associated with the function of detecting anomalous behavior among tax professionals. In practice, the tax return preparation system 110 includes many other modules and services related to providing tax return preparation services to users of the tax return preparation system 110.

As described previously, the activity monitoring system 112 monitors and collects behavioral and contextual data related to tax professionals affiliated with the tax return preparation system 110. The activity monitoring system 112 can collect the behavioral and contextual data via the special network connection by which tax professionals connect to the tax return preparation system 110. Tax professionals may need to login to the network connection hosted by the tax return preparation system 110 in order to communicate with users of the tax return preparation system 110 and to utilize the professional tax return preparation application.

The tax professionals can establish the network connection via a web browser. In order to log into the network connection, the tax professionals can navigate in the web browser to a webpage associated with the tax return preparation system. The tax professionals can then provide their login credentials such as a username, a password, an answer to a security question, or a dual authentication login key.

Alternatively, the tax professionals connect to the tax return preparation system network via an application installed on the computing devices of the tax professionals. The application can run in the background on the computing devices of the tax professionals. The tax professionals can open the application and enter login credentials in order to establish the network connection with the tax return preparation system 110.

The behavioral data can include data related to tax filings made by the affiliated tax professionals. Because the tax professionals utilize the professional tax return preparation application associated with the tax return preparation system 110, the activity monitoring system 112 can monitor any tax return filings made by the tax professionals. The activity monitoring system 112 can store the number of tax filings made by each tax professional in a given period of time. The behavioral data recorded by the activity monitoring system 112 can include a rate at which tax filings were made by each tax professional.

The activity monitoring system 112 can include seasonal tax filing rates for the tax professionals. Accordingly, the activity monitoring system 112 not only records the tax filings made by the tax professionals, but the rate at which tax filings were made during various seasons of the year. As will be described in more detail below, this can be beneficial because a tax filing rate that is normal at one time of year may be abnormally high at another time of year.

The behavioral data monitored by the activity monitoring system 112 can include login data related to instances in which tax professionals have logged into the network connection with the tax return preparation system 110, or with the professional tax return preparation application. The activity monitoring system 112 records each login instance for each tax professional. The activity monitoring system 112 can record the number of logins for each tax professional in a given period of time. The activity monitoring system 112 can record the rate of logins in given periods of time. The login data can include dates and times at which login events occurred. The activity monitoring system 112 can record seasonality data associated with logins. Thus, the behavioral data can include indications of logins and login rates during various seasons or times of the year.

The behavioral data monitored by the activity monitoring system 112 can include clickstream data associated with how the tax professionals utilized the professional tax return preparation application. The clickstream data can include the navigation of the tax professionals through the professional tax return application. The clickstream data can include specific pages or services of the professional tax return application accessed by the tax professionals. The clickstream data can indicate when tax professionals view sensitive data of users in the professional tax return preparation application. For example, the clickstream data can indicate when the tax professionals view particularly sensitive forms like the W-2 forms that include the name, Social Security number, address, employment data, and income data of users. The tax return filing data can be a subset of the clickstream data.

The behavioral data monitored by the activity monitoring system 112 can include communication data associated with communications between the tax professionals and the users of the tax return preparation system 110. The tax professionals may be required to communicate with users via the tax return preparation system 110. The types of communications enabled by the tax return preparation system 110 can include audio calls, video calls, text-based chat, and emails. The behavioral data includes data related to these types of communication.

The communication data can include transcripts of communications between the tax professionals and the users. The communication data can include transcripts of audio conversations, video conversations, and text-based conversations. The activity monitoring system 112 can analyze the topics of these discussions and record indications of the topics that were discussed in each communication. Thus, the activity monitoring system 112 may utilize voice to text transcription services. The activity monitoring system 112 may also utilize textual analysis services.

The communication data can also include the numbers and lengths of communications between tax professionals and users. The communication data can thus include the frequency with which each tax professional communicates with users. The communication data can indicate the types of communications between the tax professionals and the users.

The communication data can include video analysis data. For example, the tax return preparation system 110 may require that tax professionals have a particular setting or background when making video calls with users. These requirements may include a particular backdrop. These requirements may include that the room or environment of the tax professional be clean and uncluttered. The activity monitoring system 112 may include video analysis systems or services that enable the activity monitoring system 112 to analyze video data and determine whether the requirements were met.

The activity monitoring system 112 may further authenticate the identity of the tax professional in a video call. The activity monitoring system 112 may analyze one or more images from a video call and compare the one or more images to reference images of the tax professional. To this end, the tax professional may be required to provide one or more images or photographs when registering with the tax return preparation system. The behavioral data can indicate whether the individual in the video call matches the reference images.

The behavioral data can include data related to amounts of time that the tax professionals spent engaged with the tax return preparation system 110. Tax professionals may provide timesheets to the tax return preparation system 110 indicating the amount of time that the tax professionals spent assisting users of the tax return preparation system 110. These timesheets may be in the form of bills or invoices provided by the tax professionals to the tax return preparation system 110.

The behavioral data can include an amount of money charged by the tax professional to the tax return preparation system 110. The behavioral data can also include Internet browsing behavior of the tax professionals. Because the tax professionals are logged into a network connection with the tax return preparation system 110, the tax return preparation system 110 is able to record the types of websites visited by the user while connected to the tax return preparation system 110. The Internet browsing behavior can include whether certain categories of websites were visited by the tax professionals. The browsing behavior can include whether specific websites were visited by the tax professionals.

The contextual data collected by the activity monitoring system 112 can include data related to the location of the tax professionals while interfacing with the tax return preparation system 110. When the tax professionals register with the tax return preparation system 110, the tax return preparation system 110 may require the tax professionals to provide a geolocation from which the tax professionals will work. Each time the tax professionals connect to the tax return preparation system 110, the activity monitoring system 112 identifies the location from which the tax professionals are connecting to the tax return preparation system 110. The activity monitoring system 112 can identify the location based on the IP addresses of the tax professionals.

The contextual data can include the number of different IP addresses used by a professional in a given period of time. The contextual data can include a number of different IP addresses used in a day, a week, or month. The contextual data can also include an average number of different IP addresses used by a tax professional.

The contextual data can include the distances between locations of a tax professional during different login sessions. For example, if a tax professional uses multiple different IP addresses in a given period of time, the activity monitoring system 112 can determine the geolocations associated with the IP addresses and can calculate the distance between the geolocations.

The contextual data can include whether tax professionals have connected to the tax return preparation system 110 from a location outside an expected jurisdiction. For example, if the tax professional is credentialed to prepare and file tax returns in the United States, the activity monitoring system 112 can detect whether the user has accessed the tax return preparation system 110 from a location outside of the United States.

The contextual data can include the types of Internet connections used by the tax professionals. The activity monitoring system 112 can detect, via the network connection, whether a tax professional is connected to a cellular network or a traditional Internet service provider. The categories of network connections can be recorded.

The contextual data can also include data indicating whether a tax professional is utilizing an IP masking service, such as a VPN. An IP masking service can result in tax professionals having IP addresses that do not correspond to the true locations. The activity monitoring system 112 can record whether a tax professional has used in IP masking service during a connection session.

The contextual data can also include data indicating whether a tax professional has utilized a Tor connection. Tor connections attempt to anonymize users and hide their locations. The activity monitoring system 112 can detect whether a tax professional is utilizing a Tor connection when accessing the tax return preparation system 110. The activity monitoring system 112 records whether a Tor connection has been used by a tax professional.

FIGS. 1 and 2 have indicated an activity monitoring system 112 that is a single system. In practice, like any system, model, or module utilized by the tax return preparation system 110, the activity monitoring system 112 may utilize many different data sources and monitoring services or systems to collect the behavioral and contextual data related to tax professionals affiliated with the tax return preparation system 110.

The tax return preparation system 110 utilizes the historical data storage 116 to store contextual and behavioral data related to the tax professionals affiliated with the tax return preparation system 110. The historical data storage 116 includes historical professional data 123. The historical professional data 123 includes the contextual and behavioral data for each affiliated tax professional from all or many recorded periods of time. The historical professional data 123 can include all of the behavioral and contextual data related to the tax professionals affiliated with the tax return preparation system 110 from each recorded period of time. The historical professional data 123 includes historical behavioral data 124 and historical contextual data 126.

The term “historical” is applied in part to distinguish the historical data from the current behavioral and contextual data associated with the current data storage 120. As will be described in more detail below, the historical data storage 116 can store the data related to a tax professional from many or all recorded time periods. This is in contrast to the current data storage 120 that, in one embodiment, stores only the most recent behavioral and contextual data associated with the tax professionals. In practice, the historical data storage 116 may also store the most recent behavioral and contextual data in addition to behavioral contextual data from previous periods of time.

The historical behavioral data 124 can include, for each affiliated tax professional, the behavioral data associated with that tax professional from all recorded periods of time. The historical behavioral data 124 can include, for each affiliated tax professional, a plurality of data sets. Each data set can include the behavioral data corresponding to a particular period of time. The historical behavioral data 124 can include a data set for the most recent period of time.

The historical contextual data 126 can include, for each affiliated tax professional, the contextual data associated with that tax professional from all recorded periods of time. The historical behavioral data 124 can include, for each affiliated tax professional, a plurality of data sets. Each data set can include the contextual data corresponding to a particular period of time. The historical behavioral data 124 can include a data set for the most recent period of time.

In one embodiment, each data set for a given tax professional includes both the historical and contextual data of that tax professional in the period of time associated with that data set. Thus, the historical data storage 116 may store the historical behavioral data 124 and the historical contextual data 126 in sets of data that include the historical behavioral data and historical contextual data for a particular tax professional in a particular period of time.

In one embodiment, each data set is a feature vector. The feature vector has a plurality of data fields. Each data field corresponds to a particular type of behavioral or contextual data. Each time the activity monitoring system 112 records an event for a tax professional, a new feature vector is created. The new feature vector is the same as the next most recent feature vector, except that data values that have changed are updated. For example, a tax preparer may log into the tax return preparation system. The activity monitoring system 112 recognizes this as an event and generates a new feature vector for the tax preparer. The new feature vector is the same as the next most recent feature vector except that certain data fields are updated. If the IP address of the tax preparer is different than the most recent IP addresses, data fields associated with IP addresses and locations may be updated in the new feature vector. If the tax filing rate has changed, then the data field associated with tax filing rate is updated in the new feature vector. Accordingly, the historical data storage 116 includes, for each tax professional, a plurality of feature vectors. Further details regarding the feature vectors are provided below in relation to FIG. 3.

The machine learning training module 118 utilizes the historical professional data to generate training set data 128. The machine learning training module 118 utilizes the training set data 128 to train the analysis model 114 with one or more machine learning processes. The machine learning training module 118 trains the analysis model 114 to detect anomalous behavior among tax professionals and to identify the reasons that the behavior is considered anomalous.

The machine learning training module 118 can generate the training set data 128 by sampling the historical professional data 123. In this case, the machine learning training module 118 selects a number of tax professionals and retrieves their corresponding historical professional data 123 from the historical data storage 116. The machine learning training module 118 can then format the historical professional data 123 so that it can be fed to the analysis model 114 in a machine learning process.

In one example, the training set data includes a plurality of feature vectors. Each feature vector includes, for one of the tax professionals, historical and contextual data from a particular timestamp or period of time. The training set data may include, for each selected tax professional, several feature vectors corresponding to different times or periods of time. Each feature vector includes a plurality of data fields. Each data field corresponds to a particular item of behavioral data or contextual data.

Because misconduct among affiliated tax professionals is extremely rare, there may not be sufficient misconduct data labels to properly implement supervised learning. Accordingly, an unsupervised isolation forest machine learning model can be highly effective for training the analysis model 114 to detect anomalies or labels are not available.

In such cases, the machine learning process is an unsupervised machine learning process and the training set data does not include labels. The unlabeled training set data is passed in iterations through the machine learning training module 118. During this process, the machine learning training module 118 trains the analysis model 114 to recognize unusual or anomalous combinations of data values in the training set data 128. Highly anomalous behavior from a tax professional can be an indication of risk that the tax professional is engaged in misconduct.

The analysis model 114 can be an isolation forest model. Accordingly, the machine learning training module 118 trains the analysis model 114 with an isolation forest machine learning process. The isolation forest machine learning process generates a plurality of decision trees in the analysis model 114. Each decision tree is trained to generate an anomaly score for an input feature vector. The machine learning process can train each decision tree with a different part of the training set data 128. The machine learning process trains the analysis model to output an anomaly score that is the mean of the anomaly scores for each of the decision trees. Alternatively, the machine learning process can train the analysis model to generate an anomaly score by having all of the decision trees vote on an anomaly score.

One advantage of the isolation forest model is that the isolation forest model lends itself well to unsupervised machine learning. Accordingly, an unsupervised isolation forest machine learning model can be highly effective for training the analysis model 114 to detect anomalies or labels are not available.

Another benefit of the isolation forest model is that isolation forests lend themselves well to analyzing data sets that have different types of data values. The data center feature vectors corresponding to the behavioral and contextual data can include many different types of data values. Some data fields will have the binary type of data values. Some data fields will have continuous data values. Some data fields can include negative numbers while others cannot have negative numbers. Decision trees, and, by extension isolation forests, do not have difficulty in learning to make classifications when a single data set or feature vector includes multiple types of data values. Those of skill in the art will recognize, in light of the present disclosure, that other types of machine learning processes can be used to train the analysis model 114.

In one embodiment, the analysis model 114 includes a plurality of sub-models trained with separate machine learning processes. Each sub-model can be selected to analyze a different subset of the data fields of the feature vectors. A first sub-model may be selected to analyze a first subset of the data fields of the feature vectors. A second model may be selected to analyze a second subset of the data fields of the feature vectors, etc. The sub models can utilize different algorithms. Because they are trained separately, they will have different algorithms and may be better suited to analyze their subset of the feature vectors. Accordingly, each sub-model may be trained to detect a particular type of anomaly. For instance, one sub-model may be good at finding professional logins outside of the US. Another sub-model may be better suited for detecting anomalous clickstream activities. Scores from multiple sub-models can be normalized to the same scale and then combined into a single anomaly detection score. The final anomaly score can be generated by summing anomaly scores from sub-models, taking the mean value of anomaly scores, or by a majority vote. A supervised learning algorithm could enter such an ensemble if there are enough labels to train such a supervised algorithm.

In one example, the training set data 128 does not include an exact copy of all or a portion of the historical professional data 123. Instead, the machine learning training module 118 introduces some perturbations into the historical professional data 123. The machine learning training module 118 generates perturbed historical data 130.

The machine learning training module 118 can generate the perturbed historical data 130 by changing a very small number of data values in the historical professional data 123. In particular, the machine learning training module 118 selects a few data values from the historical professional data 123 and changes them. This can help the machine learning training process to better identify anomalies.

In some cases, there may be data fields for which every data value in all of the feature vectors in the training set data 128 have the same value. If the training set data does not include a data set or feature vector in which this value is different, then when the analysis model 114 is put into operation, the analysis model 114 may not be able to detect how anomalous the data value is. In one example, one of the data fields in the feature vectors corresponds to whether or not the tax professional utilized a Tor connection. It is possible that a training set data 128 does not include an example in which a tax professional utilized a Tor connection. To address this issue, the machine learning training module 118 changes this data field in a small number of the feature vectors to have a value indicating that the professional did use a Tor connection. Introducing the small perturbations into the training set data 128 assists the analysis model 114 to recognize this as being highly anomalous. This can improve the overall function of the analysis model 114.

In one embodiment, the machine learning training module 118 introduces binary type perturbations in data fields that represent binary data values. In one example, one of the data fields of the feature vectors corresponds to whether or not the tax professional was located outside of the United States. A value of the 0 indicates that the tax professional was within the United States. A value of 1 indicates that the tax professional was outside the United States. If all of the feature vectors in the training set include a value of 0 for this data field, then the machine learning training module 118 changes this value to 1 in a very small fraction of the feature vectors. The machine learning training module 118 may change two or three data fields out of 5000.

In one embodiment, the machine learning training module 118 introduces Gaussian type perturbations in data fields that include continuous data values. For example, a data field may correspond to an average number of tax filings per day during a given month. Theoretically, this data field could have any data value between zero and infinity. If the highest value in the training set is 30.3, the Gaussian type perturbation could include changing a few values to something beyond 30.3, thereby extending the spread of data points more in accordance with a Gaussian type distribution. Accordingly, introducing Gaussian type perturbations can include adding in data values that extend a range for that data field represented in the historical professional data 123.

In one embodiment, after the analysis model 114 is put into operation and some examples of fraudulent activity have been identified, this data can be used as labels for a supervised machine learning process. The supervised machine learning process can train the analysis model 114 to accurately identify fraudulent behavior by training the analysis model 114 to match the labels.

The machine learning process trains the analysis model to generate risk score data 136. The risk score data 136 includes a risk score for each tax professional whose data is passed to the analysis model 114. The risk score can be an anomaly score. The risk score indicates how anomalous the behavioral and contextual data is for a given tax professional. In one example, the risk score has a value between zero and one. More anomalous behavior results in risk scores closer to one. Less anomalous behavior results in risk scores closer to zero. Other scoring schemes can be used without departing from the scope of the present disclosure.

The machine learning process trains the analysis model 114 to generate reason data 138. The reason data 138 indicates a reason for high risk scores. The reason data can identify a data field or combination of data fields that that most strongly affected the risk score. The reason data can be formatted so that an automated investigative system 122 can receive the reason and understand what aspect of the feature vector resulted in the high risk score. Alternatively, or additionally, the reason data can include human readable text that a human can view and understand what caused the high risk score.

The reason data can also include a reason score for the data items listed as reasons. The reason score can indicate what percentage of or what portion of the risk score resulted from the identified data field or data fields.

The machine learning training module 118 can train the analysis model 114 to generate a correlation matrix. The correlation matrix includes rows and columns. Each row corresponds to one of the data fields from the feature vectors. Each column also corresponds to one of the data fields from the feature vectors. The data value in a given data field of the correlation matrix indicates how strongly the two corresponding features of the feature vectors correlate with each other. Thus, the correlation matrix indicates which features are related to each other. This can be useful for understanding what features of contextual behavioral data represent fraud risks.

The tax return preparation system 110 utilizes the current data storage 120 for analyzing tax professionals after the analysis model 114 has been trained. The current data storage 120 includes current professional data 131. The current professional data 131 includes current behavioral data 132 and current contextual data 134. More particularly, the current professional data 131 includes a respective data set, such as a feature vector, for each current tax profession. The feature vector includes current behavioral data 132 and current contextual data 134.

The current professional data 131 differs from the historical professional data in that the current professional data 131 includes only a single data set for each tax professional. In an example in which each data set is a feature vector including data values for various contextual and behavioral data, the current professional data 131 includes only a single feature vector for each tax professional.

The current professional data 131 is formatted and passed into the analysis model 114. Each data set or feature vector is analyzed. The analysis model 114 generates, for each tax professional, a risk score. Risk scores that are higher than a threshold risk score are flagged. Alternatively, a certain number or percentage of the highest risk scores are flagged. The analysis model 114 can generate reason data 136 for the flagged risk scores. The flagged risk scores are passed to the investigative system 122 for further investigation.

The current professional data 131 for a given tax professional is updated each time the activity monitoring system 112 retrieves new data for that tax professional. If the current professional data 131 includes a feature vector for each tax professional, that feature vector is updated each time new data is retrieved. The feature vectors and the historical professional data 123 are also updated. However, the historical professional data 123 still includes all previous feature vectors for each user, whereas the current professional data 131 includes only the most current feature vector.

In one example, the current data storage 120 can be an online data storage whose contents are frequently accessed for analysis. The historical data storage 116 is an off-line data storage whose contents are retrieved only to train the machine learning training module 118.

The analysis model 114 can analyze all of the current professional data 131 periodically. The analysis model 114 can analyze the current professional data 131 daily, weekly, or monthly. In one example, the analysis model performs analysis after selected events, such as after a login by a tax professional into the tax return preparation system 110.

Flagged risk scores are passed to the investigative system 122. The investigative system 122 can then investigate the tax professionals associated with those flagged risk scores. In some cases, the investigative system 122 can automatically temporarily suspend any flagged tax professional until the investigation is complete. In other cases, the investigative system 122 takes no action against a tax professional until an investigation is complete. The investigative system 122 can freeze the ability of the tax professional to file tax returns or communicate with users

The investigative system 122 can include automated investigative systems. The investigative system 122 can also include human investigators that investigate possible misconduct.

FIG. 3 is an illustration 300 of training set data 128 being passed to the analysis model 114 during a machine learning training process of the analysis model 114. The training set data 128 includes a plurality of feature vectors 140 for N tax professionals. Each feature vector 140 includes M data fields, DF1-DFM. Each data field corresponds to a contextual feature or a behavioral feature. Each feature vector includes the contextual and behavioral data for a given tax professional at a particular point in time.

The training set data 128 includes four feature vectors for a first tax professional, four feature vectors 140 for a second tax professional, and four feature vectors for a Nth tax professional. In practice, there may be many more than four feature vectors for each tax professional in the training set data 128. Additionally, there may be different numbers of feature vectors for each tax professional.

For example, each time a feature vector is updated, the updated feature vector is stored in the current professional data 131. However, the historical data storage 116 stores all previous versions of the feature vector for each professional in the historical data storage. The large number of historical feature vectors for each professional results in a rich training set, which in turn results in an effective training of the analysis model 114. For example, the training set data 128 can include, for each of the historical tax professionals, feature vectors for many different times of the year. These seasonally diverse feature vectors enable the training process to train the analysis model 114 to effectively identify seasonal anomalies in the current professional data 131.

In the example of FIG. 3, data fields DF1-DF5 correspond to contextual features. A first data field DF1 may correspond to whether a recent login event occurred from outside the United States. A second data field DF2 may correspond to a distance between recent login locations of a tax professional. A third data field DF3 may correspond to a number of different IP addresses used by the tax professional in a given period of time. The data fields corresponding to contextual features can include other types of contextual data such as those described herein, or types of contextual data not described herein. Additionally, in practice, there may be many more than five data fields devoted to types of contextual data.

In the example of FIG. 3, data fields DF6-DFM correspond to behavioral features. The sixth data field DF6 may correspond to a rate of tax return filings made by the tax professional in a given period of time. The seventh data field DF7 correspond to the number of audio conversations had with users. The eighth data field DF8 may correspond to a number of hours billed by the tax professional to the tax return preparation system 110 during a given time. The data fields associated with behavioral features can include many other kinds of behavioral data such as those described herein, or behavioral data not described herein.

The training set data 128 may include perturbed historical data 130. As described herein, the machine learning training module 118 may generate perturbed historical data 130 by adjusting a small number of data fields in the training set data 128.

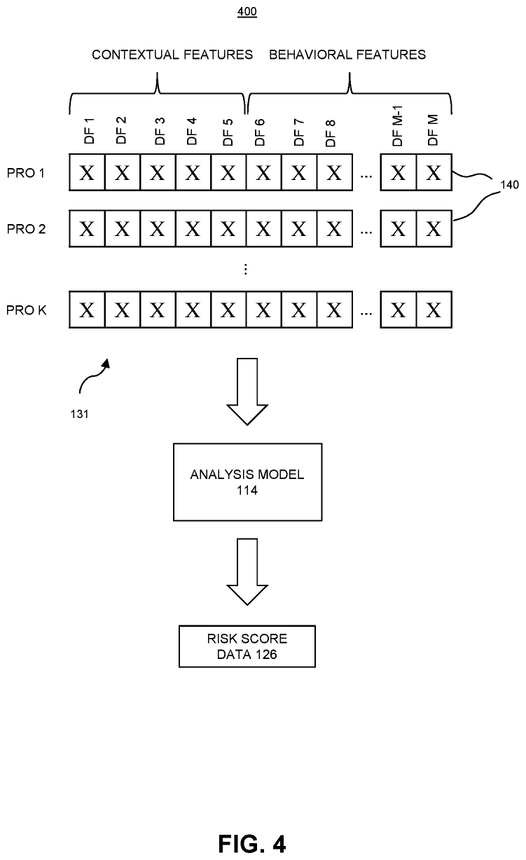

FIG. 4 is an illustration 400 of current professional data 131 being passed to the analysis model 114. The current professional data 131 includes, for each of K tax professionals, a respective feature vector 140. The feature vector 140 for each tax professional represents the most recent set of behavioral and contextual data for that tax professional.

Each feature vector 140 includes M data fields (DF1-DFM. The data fields of the feature vectors 140 in the current professional data 131 correspond to the same types of contextual or behavioral data as the feature vectors 140 in the training set data 128. The data values in the feature vectors 140 correspond to the most current contextual and behavioral data for those tax professionals.

The current professional data 131 is passed to the analysis model 114. The analysis model analyzes each feature vector 140 and generates risk score data 126. The risk score data 126 includes, for each professional, a risk score based on the corresponding feature vector 140. The analysis model 114 can also output reason data for each risk score.

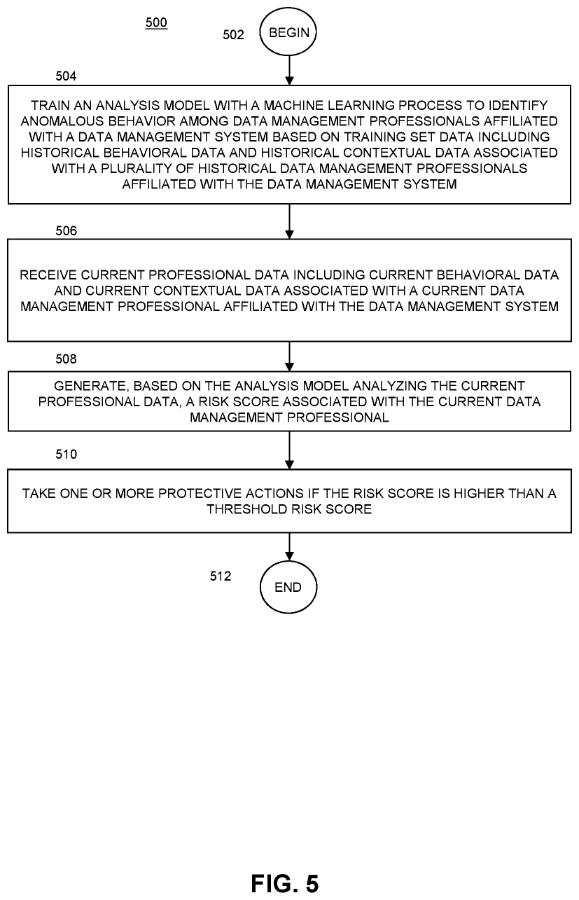

FIG. 5 illustrates a flow diagram of a process 500 for detecting anomalous behavior in tax professionals, according to various embodiments.

Referring to FIG. 5 and the description of FIGS. 1-4 above, in one embodiment, process 500 begins at 502. From 502 process flow proceeds to 504.

At 504, an analysis model is trained with a machine learning process to identify anomalous behavior among data management professionals affiliated with a data management system based on training set data including historical behavioral data and historical contextual data associated with a plurality of historical data management professionals affiliated with the data management system, using any of the methods, processes, and procedures discussed above with respect to FIGS. 1-4. From 504 process flow proceeds to 506.

At 506 current professional data is received including current behavioral data and current contextual data associated with a current data management professional affiliated with the data management system, using any of the methods, processes, and procedures discussed above with respect to FIGS. 1-4. From 506 the process proceeds to 508.

At 508 a risk score associated with the current data management professional is generated based on the analysis model analyzing the current professional data, using any of the methods, processes, and procedures discussed above with respect to FIGS. 1-4. From 508 process flow proceeds to 510.

At 510 one or more protective actions is taken if the risk score is higher than a threshold risk score, using any of the methods, processes, and procedures discussed above with respect to FIGS. 1-4. From 510 process flow proceeds to 512.

At 512 the process for detecting anomalous behavior in tax professionals is exited to await new data and/or instructions.

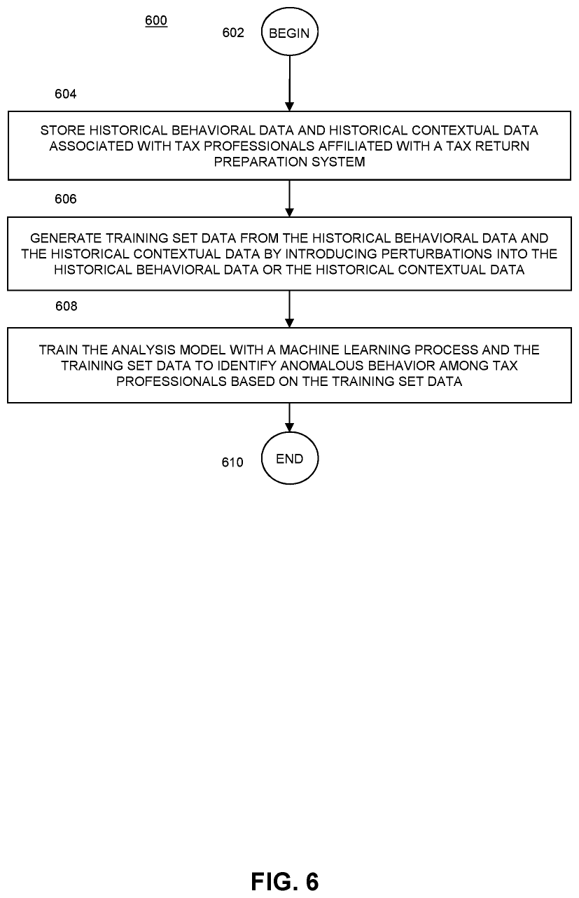

FIG. 6 illustrates a flow diagram of a process 600 for the process for detecting anomalous behavior in tax professionals, according to various embodiments.

Referring to FIG. 6, and the description of FIGS. 1-4 above, in one embodiment, process 600 begins at 602 and process flow proceeds to 604.

At 604 behavioral data and historical contextual data associated with tax professionals affiliated with a tax return preparation system are stored, using any of the methods, processes, and procedures discussed above with respect to FIGS. 1-4. From 604 process flow proceeds to 606.

At 606 training set data is generated from the historical behavioral data and the historical contextual data by introducing perturbations into the historical behavioral data or the historical contextual data, using any of the methods, processes, and procedures discussed above with respect to FIGS. 1-4. From 606 process flow proceeds to 608.

At 608 the analysis model is trained with a machine learning process and the training set data to identify anomalous behavior among tax professionals based on the training set data, using any of the methods, processes, and procedures discussed above with respect to FIGS. 1-4. From 608 process flow proceeds 610.

At 610 the process for detecting anomalous behavior in tax professionals is exited to await new data and/or instructions.

A computing system implemented method includes training an analysis model with a machine learning process to identify anomalous behavior among data management professionals affiliated with a data management system based on training set data including historical behavioral data and historical contextual data associated with a plurality of historical data management professionals affiliated with the data management system. The method includes receiving current professional data including current behavioral data and current contextual data associated with a current data management professional affiliated with the data management system. The method includes generating, based on the analysis model analyzing the current professional data, a risk score associated with the current data management professional and taking one or more protective actions if the risk score is higher than a threshold risk score.

Embodiments of the present disclosure address some of the shortcomings associated with traditional tax return preparation systems. Behavioral and contextual data is used to identify anomalous behavior among tax professionals affiliated with a tax return preparation system. The various embodiments of the disclosure can be implemented to improve the technical fields of fraud detection, electronic data management systems, data security, and data processing. Therefore, the various described embodiments of the disclosure and their associated benefits amount to significantly more than an abstract idea.

Using contextual and behavioral data to identify anomalous behavior among tax professionals affiliated with a tax return preparation system is a technical solution to a long-standing technical problem and is not an abstract idea for at least a few reasons. First, using contextual and behavioral data to identify anomalous behavior among tax professionals affiliated with a tax return preparation system is not an abstract idea because it is not merely an idea itself (e.g., can be performed mentally or using pen and paper).

Second, using contextual and behavioral data to identify anomalous behavior among tax professionals affiliated with a tax return preparation system is not an abstract idea because it is not a fundamental economic practice (e.g., is not merely creating a contractual relationship, hedging, mitigating a settlement risk, etc.).

Third, using contextual and behavioral data to identify anomalous behavior among tax professionals affiliated with a tax return preparation system is not an abstract idea because it is not a method of organizing human activity (e.g., managing a game of bingo).

Fourth, although mathematics may be used to generate an analytics model, the disclosed and claimed methods and systems of using contextual and behavioral data to identify anomalous behavior among tax professionals affiliated with a tax return preparation system are not an abstract idea because the methods and systems are not simply a mathematical relationship/formula.

Using contextual and behavioral data to identify anomalous behavior among tax professionals affiliated with a tax return preparation system yields significant improvement to the technical fields of fraud detection, data security, electronic data management, and data processing, according to one embodiment. The present disclosure adds significantly to the field of electronic data management because using contextual and behavioral data to identify anomalous behavior among tax professionals affiliated with a tax return preparation system increases the improves the overall security of users' data.

In addition to improving overall computing performance, using contextual and behavioral data to identify anomalous behavior among tax professionals affiliated with a tax return preparation system significantly improves the field of data management systems by more effectively and efficiently ensuring the security of users' data, according to one embodiment. Therefore, both human and non-human resources are utilized more efficiently.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIGs, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method comprising:
training an analysis model with a machine learning process to identify anomalous behavior among data management professionals affiliated with a data management system based on training set data including historical behavioral data and historical contextual data associated with a plurality of historical data management professionals affiliated with the data management system;
receiving current professional data including current behavioral data and current contextual data associated with a current data management professional affiliated with the data management system;
generating, based on the analysis model analyzing the current professional data, a risk score associated with the current data management professional; and
taking one or more protective actions if the risk score is higher than a threshold risk score.

2. The method of claim 1, wherein training the analysis model includes perturbing the training set data by adjusting one or more data values.

3. The method of claim 2, wherein perturbing the training set data includes changing one or more binary data values in the training set data.

4. The method of claim 3, wherein perturbing the training set data includes identifying a binary data field in the training set data for which all historical tax professionals have a same data value and changing the data value for one or more of the historical tax professionals.

5. The method of claim 3, wherein perturbing the training set data includes adjusting one or more data values in accordance with a gaussian profile to extend a range represented in the training set data for a selected data field prior to perturbation.

6. The method of claim 1, wherein the analysis model is an isolation forest model.

7. The method of claim 1, wherein the analysis model includes multiple analysis submodels.

8. The method of claim 7, wherein training the analysis model includes training each analysis submodel with a separate machine learning process, wherein the risk score is based on an output of each of the analysis submodels.

9. The method of claim 1, further comprising generating reason data indicating a reason for the risk score.

10. The method of claim 1, wherein the current behavioral data includes one or more of:
clickstream data indicating actions taken by the current data management professional within the data management system;
a chat log for a conversation between the current data management professional and a user of the data management system;
a rate for filing documents with the data management system;
login events with the data management system;
data related to an appearance of a work environment of the current data management professional during a video call with a user of the data management system; and
billing data indicating work performed by the current data management professional for the data management system.

11. The method of claim 1, wherein the current contextual data includes one or more of:
data indicating whether the current data management professional was outside an expected jurisdiction while using the data management system;
data indicating a distance between recent login locations of the current data management professional;
data indicating a number of different IP addresses associated with recent logins by the current data management professional;
data indicating websites visited by the current data management professional; and
data indicating whether the current data management professional used an IP masking system.

12. The method of claim 1, wherein training the analysis model includes training the analysis model to detect anomalies based on a time of the year associated with the historical behavioral data.

13. A computing system implemented method comprising:
storing historical behavioral data and historical contextual data associated with tax professionals affiliated with a tax return preparation system;
generating training set data from the historical behavioral data and the historical contextual data by introducing perturbations into the historical behavioral data or the historical contextual data; and
training the analysis model with a machine learning process and the training set data to identify anomalous behavior among tax professionals based on the training set data.

14. The method of claim 13, further comprising:
passing current professional data to the trained analysis model including, for each of a plurality of current tax professionals affiliated with the tax return preparation system, a respective feature vector including current behavioral data and current contextual data associated with the current tax professional;
generating risk score data including, for each current tax professional, a respective risk score;
flagging risk scores that meet risk score flagging criteria;
outputting the flagged risk scores to an investigative system; and
taking one or more protective actions.

15. The method of claim 13, wherein the machine learning process is an unsupervised machine learning process.

16. A computing system implemented method comprising:
training an analysis model with a machine learning process to identify anomalous behavior among tax professionals affiliated with a tax return preparation system;
passing, to the trained analysis model, current tax professional data including, for each of a plurality of tax professionals, a respective feature vector including current behavioral data and current contextual data associated with the current tax professional;
generating risk score data including, for each current tax professional, a respective risk score;
flagging risk scores that meet a risk score flagging criteria;
outputting the flagged risk scores to an investigative system; and
taking one or more protective actions.

17. The method of claim 16, wherein one or more protective actions includes restricting access of one or more of the tax professionals to the tax return preparation system based on findings of the investigative system.

18. The method of claim 16, wherein training the analysis model includes using training set data including historical behavioral data and historical contextual data associated with a plurality of historical tax professionals affiliated with the tax return preparation system.

19. The method of claim 18, wherein training the analysis model includes perturbing the training set data by artificially adjusting one or more data values.

20. The method of claim 18, wherein the training set includes a plurality of historical feature vectors related to the historical tax professionals.
